(19) United States
(12) Patent Application Publication
(10) Pub. No.: US 2020/0033200 A1
(43) Pub. Date: Jan. 30, 2020

(54) TURBOMACHINE COMPONENT WITH A SIGNALING DEVICE, TURBOMACHINE AND METHOD OF UPGRADING A TURBOMACHINE COMPONENT

(71) Applicant: Nuovo Pignone Tecnologie SRL, Florence (IT)

(72) Inventors: Mirco INNOCENTI, Florence (IT); Remo RIBICHINI, Florence (IT)

(21) Appl. No.: 15/580,836

(22) PCT Filed: Jun. 8, 2016
(86) PCT No.: PCT/EP2016/063021

§ 371 Date: Dec. 8, 2017

(30) Foreign Application Priority Data
Jun. 9, 2015 (IT) 102015000021977

(51) Int. Cl. G01K 13/00; F01D 5/02; G01K 3/04; G01K 11/06; G01K 11/12

(52) U.S. Cl. CPC G01K 13/00; F01D 5/02; G01K 3/04; F05B 2260/80; G01K 11/12; F05B 2230/80; G01K 11/06

(57) ABSTRACT

The turbomachine component, in particular a wheel of a gas turbine, comprises a signaling device; the signaling device is arranged to prolongedly or permanently indicate temperature exposure of a region of the component where the signaling device is located; the component may comprise a set of signaling devices. A standard component of a turbomachine may be upgraded by applying a patch of material to a surface of a region of the component to be monitored.

### TECHNICAL FIELD

Embodiments of the subject matter disclosed herein correspond to turbomachine components (in particular wheels) with signaling devices, turbomachines (in particular gas turbines), and methods of upgrading turbomachine components.

### BACKGROUND ART

During operation, the components of turbomachines are generally subject to high temperatures.

The high temperature of a component of a turbomachine may be due to direct contact with the working fluid of the turbomachine that heats during operation of the turbomachine and/or to contact with an adjacent component that heats during operation of the turbomachine. For example, the rotary blades of a gas turbine (generally called “buckets”) heat during operation as they get in contact with the hot flowing gas while the support elements of the rotary blades (generally called “wheels”) heat during operation as it is in contact with the rotary blades; therefore, normally, the buckets are designed to withstand a “high” temperature (typically higher than 700° C.) while the wheels are designed to withstand a “low” temperature (the operating temperature of a wheel may be for example in the range 350-400° C.); under anomalous conditions the wheels may heat to a “medium” temperature (risk temperatures for a wheel may correspond for example to the range 400-450° C.); often, the above-mentioned “low” temperature is much lower than the above-mentioned “high” temperature; often, the above-mentioned “medium” temperature is only a little higher than the above-mentioned “low” temperature and always quite lower than the above-mentioned “high” temperature. Such anomalous conditions may cause damages to the wheels and/or may reduce their mechanical properties.

In the field of “Oil & Gas”, the risk that a support element of a set of blades in a turbomachine, in particular a wheel of a set of buckets, experiences excessive temperature for a long time is a serious problem as a very high reliability is required to the machines in general and consequently to their components. For example, if a bucket disengages from its wheel in a running gas turbine, huge damages will occur and the gas turbine must be stopped for a long time and repaired; this means very high costs.

From patent document US 2014/0064325 A1, there is known a method for measuring temperature variations at an interface between hot combustion gases in a turbine hot gas path and cooler purge air in a turbine rotor wheelspace during normal operation. The method provides: (A) applying a pressure-sensitive paint PSP or temperature-sensitive paint TSP to a rotatable turbine component where the hot combustion gas interacts with the purge air; (B) locating at least one illumination device and at least one image-detecting device on a stationary component located proximate to the pressure sensitive paint; and, during operation of the turbine, (C) imaging color changes in the pressure sensitive paint caused by local variations in partial pressure of oxygen which changes with temperature; illuminating, color detecting and imaging is carried out by a system controller/data analysis unit.

Through the solution of patent document US 2014/0064325 A1, the “Oil & Gas” plant owner is specifically designed to monitor temperature variations inside one or more gas turbine engines of the plant in real time. Such monitoring may be carried out only if all of the illuminating device and the detecting device and the imaging device of the system controller/data analysis unit work properly; if any of these devices fails, no monitoring may occur. Furthermore, if there is a company taking care of maintaining this “Oil & Gas” plant, in particular its one or more gas turbine engines, the maintenance company can not be aware of temperature variations actually occurred inside the one or more gas turbine engines of the plant as monitoring through the solution of patent document US 2014/0064325 does not provide storage of data relating to temperature variations and therefore the plant owner can not provide such data to the maintenance company (it is to be noted that in general a plant owner may be reluctant to provide full monitoring data to a maintenance company). Therefore, for example, if a wheel is damaged by temperature variations beyond an acceptable limit or threshold (the parameter to be considered is called “temperature exposure over time”), the maintenance company would not realize it from a simple inspection of the wheel and would not replace the damaged wheel after inspecting it during a maintenance intervention.

### SUMMARY

Therefore, there is a general need for facilitating and improving maintenance of turbomachines and their components subject to temperature variations.

This need is particularly high for wheels of gas turbines in the field of “Oil & Gas”.

First embodiments of the subject matter disclosed herein relate to a turbomachine component.

According to such turbomachine component, there is a signaling device; the signaling device is arranged to prolongedly or permanently indicate temperature exposure of a region of the component where the signaling device is located.

The signaling may be arranged, for example, to prolongedly or permanently indicate exceeding a temperature exposure threshold of the region.

The signaling may be arranged, for example, to prolongedly or permanently indicate a thermal history of the region.

Second embodiments of the subject matter disclosed herein relate to a turbomachine.

According to such turbomachine, there is at least one component with a signaling device; the signaling device is arranged to prolongedly or permanently indicate temperature exposure of a region of the component where the signaling devices is located.

Third embodiments of the subject matter disclosed herein relate to a method of upgrading a component of a turbomachine.

According to such upgrading method, a component of a turbomachine, in particular a wheel of a gas turbine, a patch of material is applied to a surface of a region of the component; this material prolongedly or permanently indicates if this region has been exposed to temperature, i.e. high temperature.

### BRIEF DESCRIPTION OF DRAWINGS

The accompanying drawings, which are incorporated herein and constitute an integral part of the present specification, illustrate exemplary embodiments of the present invention and, together with the detailed description, explain these embodiments. In the drawings:

FIG. 1 shows a schematic partial cross-section view of an embodiment of a turbomachine;

FIG. 2 shows the details of FIG. 1 and is an enlarged partial cross-section view; and

FIG. 3 is a partial perspective view of a component of the turbomachine of FIG. 1.

### DETAILED DESCRIPTION

The following description of exemplary embodiments refers to the accompanying drawings.

The following description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

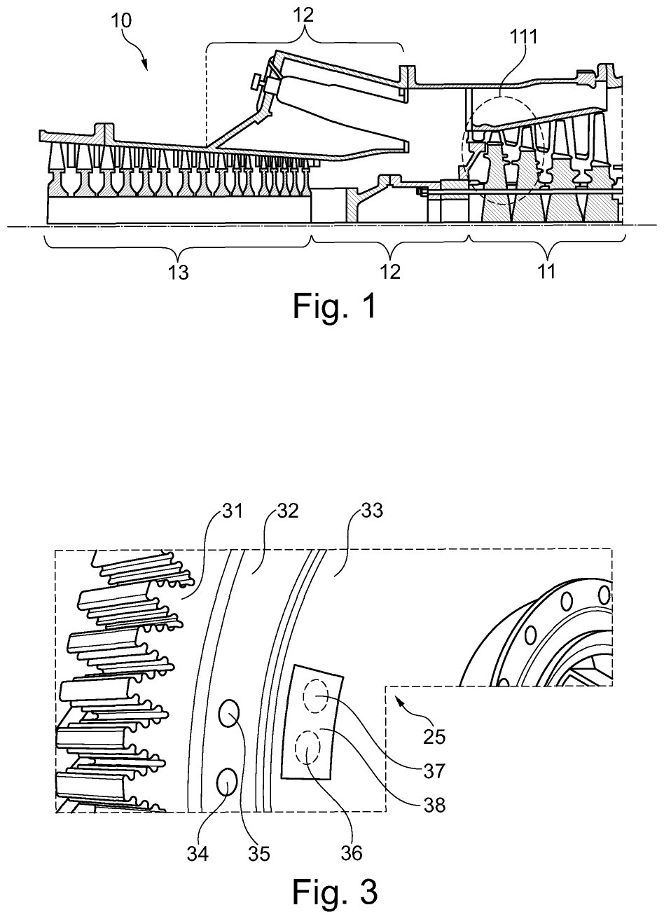

FIG. 1 shows schematically a gas turbine engine 10 comprising a turbine section 11, a combustion section 12 and a compressor section 13.

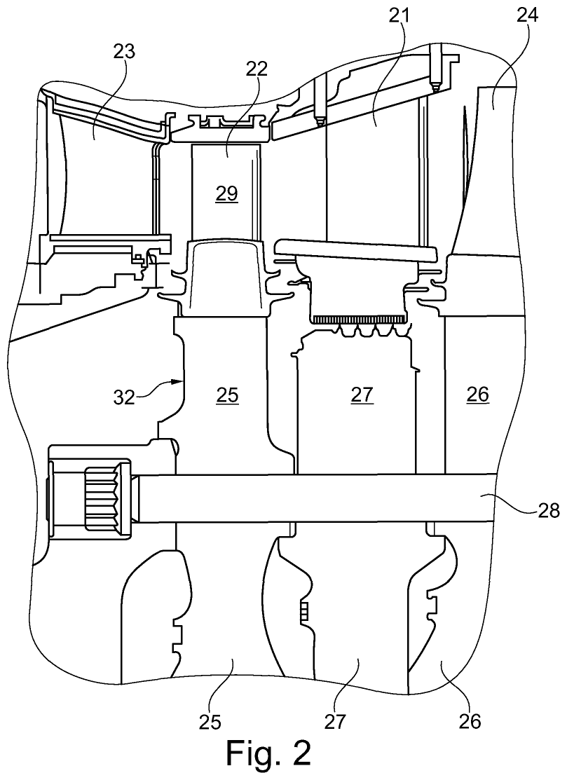

A portion 111 of the turbine section 11 have been highlighted (see the circle); FIG. 2 shows the portion 111 in detail.

FIG. 2 shows a partial cross-section view of a stationary nozzle assembly 21 and a rotating bucket assembly 22 of a stage of a gas turbine; a further stationary nozzle assembly 23 is partially shown on the left of this stage and a rotating bucket assembly 24 is partially shown on the right of this stage. A rotor is provided with axially spaced rotor wheels (25 and 26 in FIG. 2) and spacers (27 in FIG. 2) joined together by e.g. a plurality of circumferentially spaced, axially-extending, bolts (28 in FIG. 2). In the illustrated example, each of nozzle assembly 21 and nozzle assembly 23 includes a plurality of circumferentially-spaced, stationary stator blades that surround the rotor. Between the nozzle assemblies, and rotating with the rotor, there are rotor blades or “buckets” respectively mounted on rotor wheels; in FIG. 2, for example, between nozzle assemblies 21 and 23, there are rotor blades or “buckets” 29 mounted on rotor wheel 25 (that is also shown in FIG. 3 through a partial perspective view).

Each bucket (for example, bucket 29 of FIG. 2) includes an airfoil portion supported radially by a shank. A dovetail portion of the bucket 29 (radially extending inwardly to the shank and not shown in detail in FIG. 2) is adapted for connection with generally corresponding dovetail portion 31 formed in the rotor wheel 25 (see FIG. 3). Bucket is typically integrally cast and at its shank includes axially-projecting inner and outer angel wing seals that cooperate with nozzle seal lands formed on the adjacent nozzle assemblies to limit ingestion of hot combustion gases (flowing through the hot gas path) into wheelspace cavities located radially adjacent to the buckets and the rotor wheel. By alternating the angel wing seals and the nozzle seal lands and by locating them so that tortuous or serpentine radial gaps are established, hot combustion gas ingress into the wheelspace cavities is inhibited. It is to be understood that ingestion of hot combustion gases is also inhibited by cooler purge air flowing through the wheelspace cavities, some of which seeks to exit via the gap.

It is to be noted that FIG. 3 is used to describe several embodiments. According to a first embodiment only device 34 is used; according to a second embodiment only devices 34 and 35 are used; according to a third embodiment only device 36 and layer 38 are used; according to a fourth embodiment only devices 36 and 37 and layer 38 are used; according to a fifth embodiment only devices 34 and 36 and layer 38 are used; according to a sixth embodiment all devices 34, 35, 36 and 37 and layer 38 are used. A person skilled in the art understands that still other embodiments are possible.

Each of these embodiments comprises one signaling device or several signaling devices (labelled as 34, 35, 36, 37 in FIG. 3); any signaling device is arranged to indicate, in a visible way, that a region of a component (labelled as 25 in FIG. 3) has been subject to “temperature exposure”.

Such visibility may be in the “human-visible” spectrum (i.e. wavelengths from 400 to 700 nanometres) or in the IR spectrum or in the UV spectrum.

Such visibility may be natural or derived from a stimulation, for example it may be due to laser-induced luminescence.

According to first embodiments, a signaling device is arranged to indicate that a region of a component has exceeded a “temperature exposure” threshold.

This means that such device signals an event of interest, i.e. indicates, in a visible way, exceeding a “temperature exposure” threshold (which is an undesirable event). Visual indication of the occurred event of interest should continue for a long time, i.e. prolongedly, or (ideally) forever, i.e. permanently, after the occurrence of the event so that an operator of e.g. a maintenance company will be able to detect the occurred event during a subsequent maintenance intervention.

Considering the possible applications embodiments of the present invention, the event that is typically considered is not the fact that a certain region of a body has reached a certain temperature; it may be an event linked to a parameter that is a function of both temperature and time and that is called “temperature exposure over time”. According to a precise and general definition, the event may be the fact that a region of a body has been exposed to a temperature within e.g. a predetermined temperature range for a time within e.g. a predetermined time range.

As it is apparent from the “background art” section, a possible specific application of the present invention is to the wheels of gas turbines, even if this is far from being the only application.

A signaling device is located where it can be seen and accessed easily; in FIG. 3, for example, each of the signaling devices are located on the side of wheel 25, in particular only on its front side. In FIG. 3, each of the signaling devices is located on wheel 25 at its radial periphery (e.g. close to dovetail portion 31 of wheel 25 for mounting buckets 29); in fact, the radial periphery of the wheel is the portion of the wheel that is more subject to high temperatures.

A particularly effective way of embodying the or each signaling device is through a signaling patch of material applied to a surface of the component of interest; in FIG. 3, for example, two distinct surfaces 32 and 33 of component 25 are considered; each of these surfaces is annular; surface 32 is an outer surface; surface 33 is an intermediate surface (i.e. inner than surface 32).

Due to the symmetry of the component of interest, in particular the axial symmetry of wheel 25 and of bucket assembly 22, signaling devices located at different places of the component may be used for monitoring the same region of the component; in FIG. 3, for example, both devices 34 and 35 may be used for monitoring the same region of component 25 as their distance from the axis is the same, and both devices 36 and 37 may be used for monitoring the same region of component 25 as their distance from the axis is the same.

A possible and way of indicating permanently such event is by means of a “irreversible thermochromic” material; a material of this type permanently changes markedly its color when a temperature exposure or temperature exposure over time threshold has been exceeded. It is not to be excluded that the color might change after the event even if no further temperature exposure occurs, but the change should be little (and slow) and the indication should remain.

An alternative possible way of indicating permanently such event is by means of a material that changes its shape and/or position when a temperature exposure or temperature exposure over time threshold has been exceeded. The change of shape may be due, for example, to total or partial melting of the element made of such material; a possible consequence of total melting of the element may be that no element remains (and can be seen) on the component after the “event”.

A signaling device may comprise a signaling spot of paint applied to a surface of the component.

A signaling device may comprise a (small) shaped signaling layer of material applied to a surface of the component.

A signaling device may be associated to a protecting layer of material (applied e.g. over a signaling patch of material of the device); this may be useful, for example, if the material of the signaling device is not very resistant to chemical and/or mechanical actions. This corresponds, for example, to patches 36 and 37 in FIG. 3 and their protective layer 38.

Layer 38 is opaque (in fact patches 36 and 37 are drawn in dashed line); this means that it is necessary to remove this layer for inspecting the patch or the patches behind it.

Alternatively, the protecting layer may be transparent; in this case, the patch or the patches may be inspected without removing the protecting layer.

According to second embodiments, a signaling device is arranged to indicate a “thermal history” of a region of a component due to “temperature exposure”.

Many of the considerations set out in connection to the first embodiments apply also to the second embodiments.

In this case, the material of the signaling patch may be arranged to irreversibly change its material structure when exposed to temperature. Such change may be for example from the amorphous state to the crystalline state, and may cause a change in the luminescence properties of the material.

During inspection, when the component is at e.g. room temperature, a check device may induce luminescence of the signaling patch through a laser, detect light emitted by the patch and correlate it to a thermal history of the patch (and the component) using e.g. a predetermined reference curve.

As already said, more than one signaling device is used for one component.

One or more signalling devices may be arranged to prolongedly or permanently indicate exceeding a temperature exposure threshold of a region.

One or more signalling devices may be arranged to prolongedly or permanently indicate a thermal history of a region.

According to a first example, there may be a first signaling device (e.g. 34 or 36) and a second signaling device (e.g. 35 or 37); the first signaling device (34 or 36) may be arranged to permanently indicate exceeding a first temperature exposure threshold of a specific region of the component (25); the second signaling device (35 or 37) may be arranged to permanently indicate exceeding a second temperature exposure threshold of the same specific region of the component (25).

According to a second example, there may be a first signaling device (e.g. 34 or 35) and a second signaling device (e.g. 36 or 37); the first signaling device (34 or 35) may be arranged to permanently indicate exceeding a first temperature exposure threshold of a first region of the component (25); the second signaling device (36 or 37) may be arranged to permanently indicate exceeding a second temperature exposure threshold of a second region of the component (25); the first and second thresholds may be identical or different.

One or more signaling devices identical or similar to those that has just been described (see e.g. FIG. 3) may be used for example in a turbomachine, more specifically in a gas turbine engine (see e.g. FIG. 1), even more specifically in a turbine section of a gas turbine engine (see FIG. 1).

It is to be noted that a signaling device may be provided at the time of production of a component of a turbomachine. Alternatively, it may be provided after the production of the component, for example at the time of assembling or reassembling the turbomachine.

In an embodiment, one or more signaling devices identical or similar to those that has just been described may be added to a component of a turbomachine for upgrading it, specifically for improving it, for example at a maintenance intervention; in fact, a upgraded component for such signaling device allows a better and easier maintenance.

Such upgrading is quick and easy as applying a patch of material to a surface of a region of the component is quick and relatively easy to be carried out.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A turbomachine component comprising a signaling device, the signaling device being arranged to prolongedly or permanently indicate temperature exposure of a region of the component where the signaling device is located.

2. The turbomachine component of claim 1, wherein the signaling is arranged to prolongedly or permanently indicate exceeding a temperature exposure threshold of the region.

3. The turbomachine component of claim 1, wherein the signaling is arranged to prolongedly or permanently indicate a thermal history of the region.

4. The turbomachine component of claim 1 being a wheel of a gas turbine.

5. The turbomachine component of claim 1, wherein the signaling device comprises a signaling patch of material applied to a surface of the component.

6. The turbomachine component of claim 5, wherein the signaling device may be associated to a protecting layer of material applied over said signaling patch of material.

7. The turbomachine component of claim 5, wherein the material of the signaling patch is irreversible thermochromic.

8. The turbomachine component of claim 5, wherein the material of the signaling patch is arranged to irreversibly change its material structure when exposed to temperature.

9. The turbomachine component of claim 5, wherein the material of the signaling patch is laser-induced luminescent.

10. The turbomachine component of claim 5, wherein the material of the signaling patch is meltable and is arranged to irreversibly change its shape and/or position when exposed to temperature.

11. The turbomachine component of claim 1, further comprising at least a first signaling device and a second signaling device.

12. The turbomachine component of claim 11, wherein the first signaling device is arranged to prolongedly or permanently indicate first temperature exposure of a specific region of the component, wherein the second signaling device is arranged to prolongedly or permanently indicate second temperature exposure of said specific region of the component.

13. A turbomachine comprising one component according to claim 1.

14. A gas turbine comprising a plurality of components according to claim 1, wherein said components are wheels.

15. A method of upgrading a component of a turbomachine, in particular a wheel of a gas turbine, comprising the step of applying a patch of material to a surface of a region of the component, wherein said material prolongedly or permanently indicates if said region has been exposed to temperature.
